(19) United States
(12) Patent Application Publication
(10) Pub. No.: US 2017/0163850 A1
(43) Pub. Date: Jun. 8, 2017

(54) OUT-OF-GAMUT SCORE

(71) Applicant: Jostens, Inc., Minneapolis, MN (US)

(72) Inventors: Mike Heeter, Bloomington, MN (US); Art Grundfast, Clarksville, TN (US); Doug Griffith, Clarksville, TN (US)

(21) Appl. No.: 15/367,418

(22) Filed: Dec. 2, 2016

Related U.S. Application Data
(60) Provisional application No. 62/262,054, filed on Dec. 2, 2015.

(51) Int. Cl. H04N 1/60; G06T 7/40

(52) U.S. Cl. CPC H04N 1/6052; H04N 1/6008; H04N 1/6061; G06T 7/408; G06T 2207/10024

(57) ABSTRACT

A method for determining whether an image or color is out of gamut for a device. The method may include receiving a source image or color in a first color space, the first color space corresponding to a first device, converting the image or color to a second color space, the second color space corresponding to a second device, converting the image or color back to the first color space to produce a converted image, comparing the source image or color and the converted image or color, and calculating an out-of-gamut score for the converted image or color. In some embodiments, an out-of-gamut score may be compared to a threshold value, and in some embodiments, the method may include notifying a user if the out-of-gamut score exceeds the threshold.

product incorporates color, differences may occur between the color viewed on the screen, during the design process, and the color rendered in the product produced by the printer due to differing color spaces and/or gamuts of the two devices. As such, the published or otherwise finished product may appear different than it did during the design process.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one or more embodiments, relates to a method for determining whether an image is out of gamut for a device. The method may include the steps of receiving a source image in a first color space, the first color space corresponding to a first device, converting the image to a second color space, the second color space corresponding to a second device, converting the image back to the first color space to produce a converted image, comparing the source image and the converted image, and calculating an out-of-gamut score for the converted image. In some embodiments, the source image and converted image may each comprise a plurality of pixels. An out-of-gamut score may be the root mean square variance between the plurality of pixels in the source image and the plurality of pixels in the converted image. In some embodiments, calculating an out-of-gamut score may include plotting the plurality of pixels of the source image and the plurality of pixels in the converted image to determine a pixel-wise distance. In some embodiments, the first color space may be defined as an RGB color space, and the second color space may be defined as a CMYK color space. In some embodiments, an out-of-gamut score may be compared to a threshold value, and in some embodiments, the method may include notifying a user if the out-of-gamut score exceeds the threshold. Furthermore, in some embodiments, an out-of-gamut score may be calculated for an individual color channel.

The present disclosure, in one or more embodiments, further relates to a method for determining whether an image is out of gamut for a device. The method may include importing an image to a first color space to produce a source image, converting at least a portion of the image to a second color space, converting the at least a portion of the image back to the first color space to produce a converted image, and based on the comparison, calculating an out-of-gamut score for the converted image.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a flow diagram depicting a method of determining whether a color or image is out of gamut according to one or more embodiments.

FIG. 2 is a flow diagram depicting a conversion of a color or image (I) to (I′) according to one or more embodiments.

FIG. 3 is a flow diagram depicting a conversion of a color or image (1) to HSV(I) and to HSV(I′) according to one or more embodiments.

FIG. 4 is a schematic diagram of a yearbook production system according to one or more embodiments.

### DETAILED DESCRIPTION

The present disclosure, in one or more embodiments, relates to methods for determining whether an image is out of gamut for a color space. Particularly, the present disclosure relates to methods for comparing a color or image in one color space to an approximation of how that color or image will appear in a different color space. In this way, methods of the present disclosure allow a user to determine whether a color or image, as it may appear on one device operating in one color space, will translate accurately or as expected to a different device operating in a different color space. For example, methods of the present disclosure may allow a user to determine whether a particular color or image, as it appears on a computer screen, will appear the same or similar when printed on a printing device.

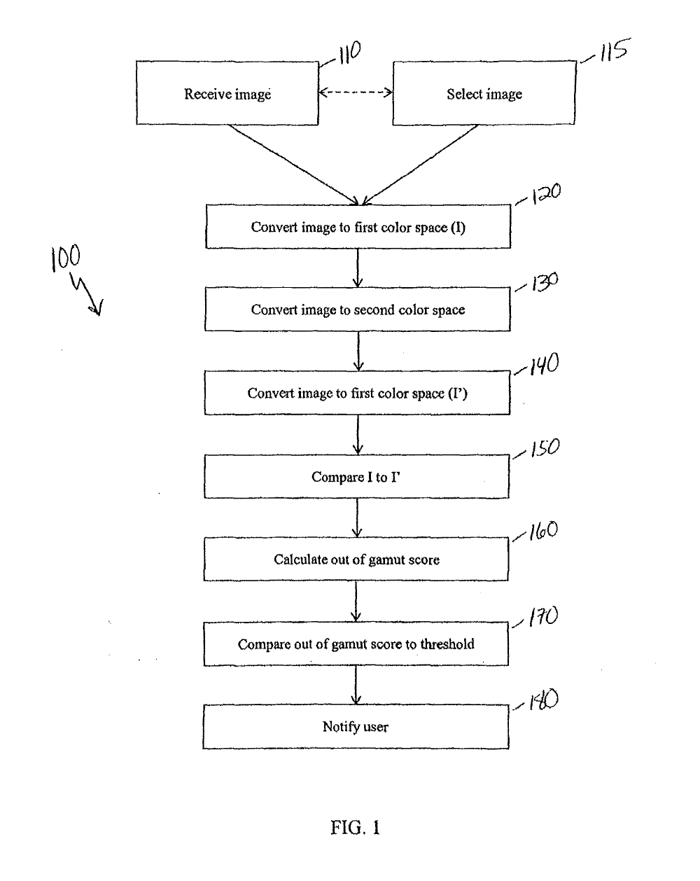

Referring now to FIG. 1, a method 100 may be used to determine whether an image may appear differently in a second color space than it does in a first color space. The method may include receiving an image (110), selecting an image (115), converting the image to a first color space (120), converting the image to a second color space (130), converting the image back to the first color space, (140), comparing the converted image to the originally received or selected image (150), calculating an out-of-gamut score for the image based on the comparison (160), comparing the out-of-gamut score to a threshold (170), and notifying a user of the result (180).

As shown in FIG. 1, an image may be received (110). The received image may be received at a computing device having the first color space, such as a desktop computer, laptop computer, tablet computer, mobile device, or other device. The computing device may generally have a monitor or screen on which the image may be viewable. The image may generally be received in a digital format, such in .jpg, .png, .gif, .pdf, .doc, .icc, an abstract format such as LAB, or other digital formats. A received image may be a photograph, clip art, drawing, text, design, or other image. In some embodiments, the image may include multiple design elements. For example, the image may be a page having one or more photographs, text, and other elements. The image may be received automatically in some embodiments. In other embodiments, a local or remote user may initiate the receiving by, for example, selecting the image to be received. In some embodiments, multiple images may be received concurrently, such as in a batch download for example.

The image may be received from a source, such as the Internet, a scanner, a camera, another device, or a remote or local data storage space, for example. The image may be received from a digital scanner, for example, wherein a physical image may be digitally scanned and sent to the computing device as a digital file. The image may be downloaded from the Internet or from a remote or cloud storage space such as Dropbox, Google Drive, Box.net, or Jostens Replay It photo sharing platform in some embodiments. The image may be uploaded from a device or storage space, such as a thumb drive, digital camera, smartphone, disk, or other device or storage space. In some embodiments, the image may already be digitally stored at the computing device, such as on an internal or external hard drive, for example. Multiple images may be received from a single source or from more than one source in some embodiments.

In addition to or alternative to receiving an image, in some embodiments, an image may be selected (115). That is, an image may be selected for conversion. The image may be located locally or remotely. For example, a user may log into a remote work station and select an image stored remotely. The selection may occur via user input or may occur automatically or partially automatically. In some embodiments, a user may select an image to be converted, and send it over a wired or wireless network to be converted, for example.

In some embodiments, the received or selected image may be imported to a first color space (120). The received or selected image may be in a source format when received or selected, such as a camera color space for example. The received or selected image may be converted to a first color space, such as a web-viewable color space. The first color space may be an RGB, sRGB, Adobe RGB, CMYK, and/or LAB color space, for example. Other color spaces may include U.S. Sheetfed Coated, U.S. Sheetfed Uncoated, U.S. Web Coated, and/or U.S. Web Uncoated. A variety of other color spaces are contemplated as well. The first color space may include the use of International Color Consortium (ICC) color spaces or profiles in some embodiments. The first color space may additionally or alternatively include other color spaces or profiles in some embodiments. In other embodiments, the received or selected image may be already represented in the first color space, without the need to import the image to the first color space.

In some embodiments, a user may make changes to the received or selected image. Changes may be made while the image is in its initial source format, in the first color space, and/or in a different color space or format. Changes may include, for example, editing the image coloring, applying a photo filter, editing the saturation of the image, or editing other image properties. A user may crop or resize the image, or may add text or a border. A user may additionally or alternatively incorporate the image with other images and/or design elements. For example, the image may be incorporated into a page having other images, text, graphics, borders, and/or other design elements. Such a page may have areas or design elements with particular color selections. The image, group of images, page, group of pages, or other component, as represented in the first color space, may be considered a pre-conversion image (I).

With continued reference to FIG. 1, the image may be digitally converted from the first color space to a second color space (130). The second color space may be an RGB, sRGB, Adobe RGB, CMYK, and/or LAB color space, or other color space, different from the first color space, for example. Other color spaces may include U.S. Sheetfed Coated, U.S. Sheetfed Uncoated, U.S. Web Coated, and/or U.S. Web Uncoated. A variety of other color spaces are contemplated as well. The second color space may be the color space of an intended output device, such as a printing press, in some embodiments. For example, the second color space may be a CMYK profile or particular color profile that coordinates with a particular device, paper, and/or ink, such as a Jostens custom profile. The second color space may include the use of International Color Consortium (ICC) color spaces or profiles in some embodiments. The second color space may additionally or alternatively include other color spaces or profiles in some embodiments. In some embodiments, the image may be converted on a pixel-by-pixel basis, such that each pixel of the image may be reconfigured using the color pallet of the second color space. The second color space may be the color space used by a particular device, such as a printer for example. For example, the second color space may be that of a printer that will ultimately produce a physical rendering of the image. Thus, converting the image to the second color space 130 may provide a preview or at least a close approximation of how the image may ultimately appear after production or rendering at the second device. The conversion may create a file, store a file, or otherwise make a file based on the second color space.

With continued reference to FIG. 1, the image may be converted from the second color space to the first color space (140). In this way, after the image is converted from the first color space to the second color space, it may be converted back to the first color space. For example, an image may initially be in an RGB color space. The image may be converted to CMYK, and then the CMYK image configuration may be converted back to RGB. The result may provide an approximation, viewable in the first color space, of how the image may appear when converted to a second color space. For example, where the image is received at a desktop computer operating in an RGB color space, but will ultimately be printed on a printer operating in a CMYK color space, conversion of the image to CMYK and back to RGB may provide a user at the computer an approximation of how the printed image will look, without the need to physically print the image. The step of converting the image back to the first color space (140) may allow the approximation to be viewed or analyzed at the computing device and compared to its pre-conversion counterpart. The image produced at step 140 may be a post-conversion image (I′).

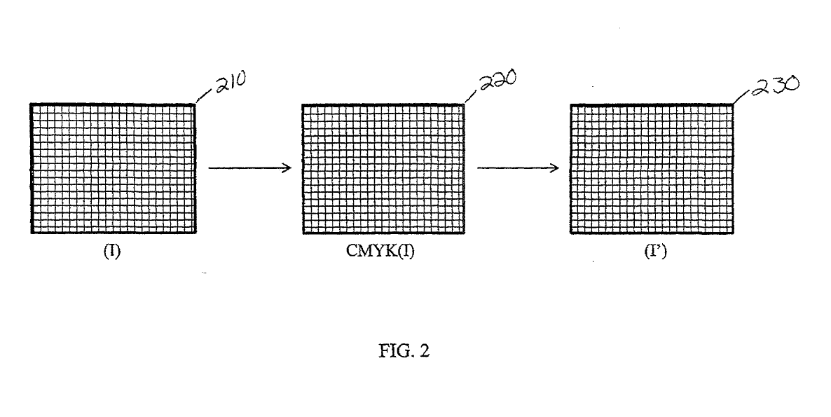

FIG. 2 illustrates one example of conversion steps 130 and 140. As shown in FIG. 2, an image (I) 210 may be in a first color space, such as RGB. Each pixel of the image (I) may be designated by RGB color space values, having a color coordinate for each of red, green, and blue, for example. The image may be converted to a second color space, such as CMYK, resulting in CMYK(I) 220. CMYK(I) 220 may represent each pixel of image (I) converted from having RGB coordinates to having CMYK coordinates representing the most similar color. The image may be converted back to the first color space, such as RGB, such that each pixel of image (I) may be converted from having CMYK coordinates back to having RGB coordinates representing the most similar color. The image reproduced in the first color space may be represented as (I′) 230. Image (I) and image (I′) may have different color RGB color coordinates in at least some pixels, because the conversion to CMYK may have slightly altered the original coloring of one or more colors of the image. In this way, the post-conversion image (I′) may represent an approximation in the RGB color space of how the image might appear in the CMYK color space or at least provide a basis on which the amount of alteration can be discerned for converting the image to the CMYK color space. In this example, the relationship of (I) to (I′) may be represented as:

I′=RGB(CMYK(I))

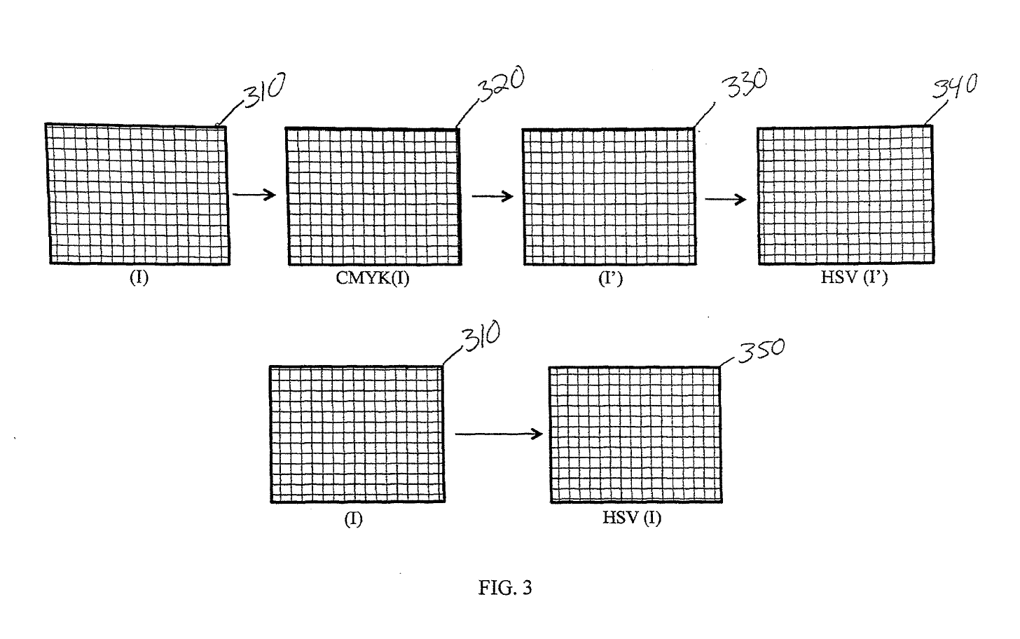

FIG. 3 illustrates another example of conversion steps 130 and 140. In some embodiments, as shown in FIG. 3, a pre-conversion image (I) and post-conversion image (I′) may each be converted to a third color space for comparison. In some embodiments, the third color space may be an RGB, sRGB, Adobe RGB, CMYK, and/or LAB color space, for example. In some embodiments, the third color space may be an HSV color space. In some embodiments, the third color space may provide for a color space that is particularly representative of the human visual system. As shown in FIG. 3, an image (I) 310 may be in a first color space, such as RGB. Similar to FIG. 2, the image (I) 310 may be converted to a second color space, such as CMYK, resulting in CMYK(I) 320, and back to the first color space, producing the post-conversion image (I′) 330. In addition, each of the post-conversion image (I′) 330 and the pre-conversion image (I) 310 may be further converted to a third color space, such as HSV. The conversion to a third color space may produce images HSV(I′) 340 and HSV(I) 350. In this way, images HSV(I) 350 and HSV(I′) 340 may be compared in addition to or alternative to any comparison performed in the first color space. This may allow for image (I) and (I′) to be compared in a third color space, separate from the first or second color spaces. In this example, the relationship of (I) to HSV(I′) may be represented as:

HSV(I′)=HSV(RGB(CMYK(I)))

Referring back to FIG. 1, the pre-conversion image (I), or alternatively HSV(I), and post-conversion image (I′), or alternatively HSV(I′), may be compared (150). The two images may be compared and/or co-registered as a whole in some embodiments, or on a pixel-by-pixel basis in some embodiments, to determine color variances. That is, in some embodiments, each pixel of the pre-conversion image (I) may be compared to its corresponding pixel of the post-conversion image (I′). This may involve a comparison of the respective pixel colors and/or a comparison of the underlying color coordinate of each pixel. In other embodiments, the two images (I) and (I′) may be compared in other ways. For example, particular color values, hues, or quantities in the two images may be compared. Other comparisons are contemplated by the present disclosure as well.

In some embodiments, a score may be determined or calculated to quantify the color variance between the pre-conversion image (I) and post-conversion image (I′) (160). The score may be determined or calculated based on the comparison step 140. In some embodiments, the out-of-gamut score may be determined by comparing the results of step 140 to a scale or control image, for example. In other embodiments, the out-of-gamut score may be determined using one or more calculations. For example, a root mean square variance (γ) between corresponding pixels (p) or color coordinates of pixels in images (I) and (I′) may be calculated. The calculation may be represented as follows:

$$γ = \sqrt{{\sum }_{p = 1}^{p = n} {( {I}_{p} - {I}_{p}^{′} )}^{2}}$$

As such, the root mean square variance (γ) may be calculated by summing the color space distance between corresponding pixels of images (I) and (I′). That is, for example, in an RGB color space having R, G, and B axes in a 3-D space, where pixel (Iₚ) of image (I) is located at one point in the color space having R, G, and B coordinates, and the corresponding pixel (P′ₚ) of image (I′) is located at another point in the color space having R, G, and B coordinates, the distance (Iₚ-p′ₚ) between the two points may be calculated. In some cases, the distance between corresponding pixels may be zero. The distances between all of the corresponding pixels, or between at least a portion of the corresponding pixels may be squared and summed. The square root of the summed squares may provide the root mean square variance (γ), as depicted in the above equation.

Additionally or alternatively, a root mean square variance (γ) may be calculated in a different color space, such as an HSV color space. For example, the pixel-wise distance between images HSV(I) and HSV(I′) may be calculated. That is, for example, in an HSV color space having H, S, and V axes in a 3-D space, where pixel (Iₚ) of image HSV(I) is located at one point in the color space having H, S, and V coordinates, and the corresponding pixel (Pₚ) of image HSV(I′) is located at another point in the color space having H, S, and V coordinates, the distance (Iₚ-I′ₚ) between the two points may be calculated. It may be appreciated that other coordinates and 3-D spaces may be used to calculate a pixel-wise distance. For example, the distance may be calculated for pixels in a different 3-D space, such as a conical space having hue (H), saturation (S), and brightness (B) axes.

The root mean square variance en may be an out-of-gamut score for an image. Or in some embodiments, the root mean square variance may be further altered or compared to a chart or to one or more control values to determine an out-of-gamut score. For example, root mean square values falling in a particular range may receive one score, while root mean square values outside of the range may receive a different score. Additionally or alternatively, other scores may be calculated to quantify the variance between the two images. In some embodiments, for example, an out-of-gamut score may be calculated as or calculated using the mean of the pixel-wise distances between images (I) and (I′). That is, the average distance between corresponding pixels (Iₚ) and (I′ₚ) may be calculated. In other embodiments, the median or mode of the pixel-wise distances between the images may be used, for example. In still other embodiments, the root mean variance may be calculated as or used to calculate an out-of-gamut score. Other calculations for determining an out-of-gamut score are contemplated as well.

In some embodiments, an out-of-gamut score, such as a root mean square variance or other calculation, may be calculated for one or more individual color channels. For example, in an RGB color space having R, G, and B axes, and where each pixel of an image has a coordinate along each of the three axes, an out-of-gamut score may be calculated or determined for the red channel (R), the green channel (G), and/or the blue channel (B). To calculate the root mean square variance (γᵣ) between images (I) and (I′) for the red channel, for example, the distance between the (R) coordinates for corresponding pixels between images (I) and (I′) may be calculated, squared, and summed. The square root of the resulting number may provide a root mean square variance of the red channel. Similarly, in an HSV color space having H, S, and V axes, and where each pixel of an image has a coordinate along each of the three axes, an out-of-gamut score may be calculated or determined for the hue (H), the saturation (S), and/or the value or luminance channel (V). Other calculations or methods for determining an out-of-gamut score for a particular color channel may be used in other embodiments. Scores for particular color channels may allow a user to determine which color(s) of image (I) may not be represented accurately or as expected in the second color space. Individual color channel scores may provide an indication of particular regions or areas of image (I′) that may be out of gamut or may visually appear different. In some embodiments individual color channel scores may be weighted differently to determine an overall out-of-gamut score for the image. For example, in an RGB color space, the green (G) channel may be weighted more heavily than the red (R) or blue (B) channels, as the human eye may be more sensitive to the color. Similarly, in an HSV color space, the hue (H) channel may be weighted more heavily than the saturation (S) or luminance (V) channels. In some embodiments, other scores may additionally or alternatively be calculated to quantify the differences between the pre- and post-conversion images.

In some embodiments, an out-of-gamut score may be calculated for a particular color of the pre-conversion image (I). For example, a user may select a particular color in image (I) by using a tool, such as a digital eyedropper tool, to select the particular color in one or more locations where it appears in the image (I). The user may select one or more pixels or, for example, may outline a region of the image (I) having the particular color. The selected color may generally be any color found in image (I). An out-of-gamut score may be calculated for the particular color by, for example, calculating the root mean square variance of the pixel-wise distance for pixels having the particular color found in image (I) and corresponding pixels of image (I′).

An out-of-gamut score may be calculated for an image automatically, or may be calculated after some user input. In some embodiments, an out-of-gamut score may be calculated upon an image being received in the first color space. The conversion and calculation may be performed during, concurrent with, or subsequent to an upload or download process in some embodiments. In other embodiments, an out-of-gamut score may be calculated at a user's initiation or request, for example. An out-of-gamut score calculation may be performed using graphics software in some embodiments, such as Aurigma Graphics Mill, Adobe Photoshop, and/or Python Imaging Library, for example. In other embodiments, other software products, applications, plugins, and/or other tools may be used to calculate an out-of-gamut score. In some embodiments, an out-of-gamut score and/or a copy of the pre-conversion image (I′) may be stored for later analysis. For example, an out-of-gamut score may be calculated during an upload or download process and stored, for example in a database. In some embodiments, a meta analysis may then be completed for a collection of stored out-of-gamut scores, for example to determine a percentage of individual images that may be out of gamut for an entire yearbook.

With continued reference to FIG. 1, an out-of-gamut score for an image may be compared to one or more threshold values (170). A threshold may be a pre-determined value and/or may represent a cutoff point for categorizing images or image colors. For example, a threshold may be a score above or below which the color variance between images (I) and (I′) may be objectively noticeable. In other embodiments, an out-of-gamut score threshold may represent a different cutoff point. In some embodiments, where an out-of-gamut score is determined for one or more individual color channels, each color channel score may be compared to a color channel threshold, for example. In some embodiments, an out-of-gamut score may be compared to more than one threshold. For example, a first threshold may represent a score above or below which color variance may be noticeable to some users, and a second threshold may represent a score above or below which a color variance may be noticeable to most users.

With continued reference to FIG. 1, in some embodiments, a notification may be issued when an out-of-gamut score exceeds or falls below a particular threshold (180). For example, where an out-of-gamut score for an image exceeds a threshold above which the color variance between (I) and (I′) may be objectively noticeable, the user may receive a warning, error, or other notification. The notification may serve to alert the user to the possibility or likelihood that a particular image or region or an image may be out of gamut or contain one or more colors that may be out of gamut for the second color space. Where the second color space is that of a printing or other production device, this may alert the user that a particular image may appear differently when printed or produced. A notification may be issued to more than one user at more than one device in some embodiments. In some embodiments, an out-of-gamut score for an image may be calculated, for example during an upload or download process of the image, and stored such that if and when a user attempts to use or view the image, the user may be alerted to the out-of-gamut score. In some embodiments, a user may be presented with a copy of the post-conversion image (I′) or an option to view the post-conversion image when the user receives the notification.

Method 100 may be initiated automatically or by some user input or activation in some embodiments. In some embodiments, the method 100 may be performed concurrent with, during, or subsequent to an image being received at the first device and/or in the first color space. Where multiple images are received concurrently or subsequent to one another, such as in a batch download or upload for example, the method 100 may be performed for each image. The method 100 may be performed during the batch download or upload of the images in some embodiments. Where multiple images are received, the notification step (180) may be performed for each image, or in some embodiments, a user may receive a single notification for the plurality of images. For example, a notification may be issued to inform a user that one or more images of the plurality has an out-of-gamut score exceeding or falling below a particular threshold. In some embodiments, the user may then take further action to address the images to determine which image(s) is out of gamut. In other embodiments, a user may receive a single notice with information regarding which of the plurality of images is out of gamut. Other notification procedures for a batch download or upload may be contemplated as well.

It may be appreciated that the methods of the present disclosure may be used to provide an estimation or approximation of how a particular color may appear in a color space. For example, method 100 may be used where a particular color is received or selected in the first color space. The color may be converted to the second color space, and converted back to the first color space. The converted color may then be compared back to the originally received or selected color. An out-of-gamut score may be calculated for the comparison in some embodiments. The out-of-gamut score may be compared to a threshold, and a user may be notified of the result. The method may be used to convert and compare a particular color or multiple colors such as a color pallet, for example.

It may be further appreciated that the methods of the present disclosure may be used to provide an estimation or approximation of how a particular portion of an image may appear in a color space. For example, a user may select a particular color found in an image in a first color space, such that the particular color may be converted to the second color space, and converted back to the first color space. The converted color may then be compared back to the color originally selected for conversion in the first color space. An out-of-gamut score may be calculated for the particular color and, in some embodiments, compared to a threshold. In some embodiments, a particular region or area of an image in the first color space may be selected for conversion and comparison, such that an out-of-gamut score may be calculated for the particular region or area.

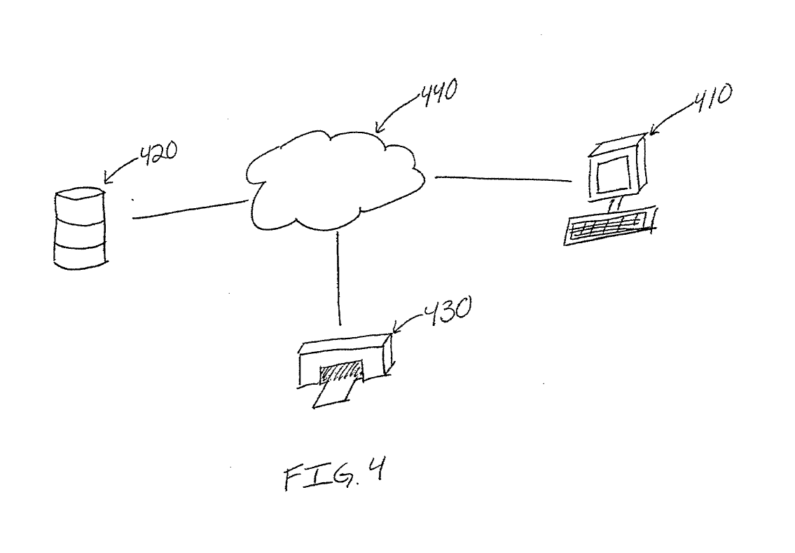

Methods of the present disclosure may be used In yearbook design and/or production in some embodiments. For example, a yearbook may be designed, at least in part, using a device operating in a color space such as RGB. However, the yearbook may ultimately be printed or produced, at least in part, using a printer operating in a different color space such as CMYK. Methods of the present disclosure may assist a user in determining which photos, designs, or colors to use in a yearbook design, or whether and how to edit such photos, designs, or colors. For example, FIG. 4 shows a schematic of one embodiment of yearbook design system. As shown in FIG. 4, a computer 410, database 420, and printer 430 may each be in communication over one or more wired or wireless networks 440. The computer 410 may be a desktop, laptop, tablet, mobile device, or other computing device and may be used to design a yearbook or a portion of a yearbook using design software contained on the database 420. The database 420 may include more than one database in some embodiments, each of which may be local or remote. Software, applications, plugins, and/or other tools for calculating an out-of-gamut score for an image may also be stored on the database 430. The database 420 may additionally contain a page ladder for organizing pages of a yearbook, an image library for organizing photos, and/or other yearbook design tools described in U.S. Pat. No. 7,757,166, entitled System and Method for Yearbook Creation, U.S. Pat. No. 5,900,002, entitled Method and Apparatus for Manipulating Page Layouts in a Desktop Publishing System; U.S. patent application Ser. No. 13/547,615, entitled System and Method for Yearbook Creation and filed Aug. 12, 2012; U.S. patent application Ser. No. 13/361,841, entitled System and Method for Yearbook Creation and filed Jan. 30, 2012; U.S. patent application Ser. No. 13/361, 821, entitled System and Method for Yearbook Creation and filed Jan. 30, 2012; U.S. patent application Ser. No. 13/946,744, entitled Foundational Tool for Template Creation and filed Aug. 19, 2013; and U.S. Provisional Patent Application No. 62/139,261, entitled Yearbook Publishing System and filed Mar. 27, 2015; each of which is hereby incorporated herein by reference in its entirety. The printer 430 may be any suitable printing device for printing at least a portion of a yearbook.

In some embodiments, the computer 410 and printer 430 may operate in different color spaces. For example, while the computer 410 may operate in an RGB color space, the printer 430 may operate in a CMYK color space. Where the computer 410 and printer 430 operate in different color spaces, a particular color may appear different when viewed at the computer than when rendered by the printer. This may lead to unexpected results or dissatisfaction when a particular image, design, or color appears with different coloring than expected when the yearbook is printed. Thus, methods of the present disclosure may operate to notify a user at either or both the computer 410 and the printer 430 of potential color variance by way of an out-of-gamut score.

In some embodiments, an out-of-gamut score may be calculated in conjunction with a particular design software. For example, in some embodiments, an out-of-gamut score may be calculated when a new image is placed into an Adobe InDesign, Adobe Photoshop, Quark, Corel, or other design software workspace. A plugin or other preconfigured setting or tool may provide access to out-of-gamut score calculation within a particular design software space. In some embodiments, the out-of-gamut score calculation may be provided over a web-based system or a cloud-based system, such as the web-based and cloud-based systems described in U.S. Provisional Patent Application No. 62/139,261, entitled Yearbook Publishing System and filed Mar. 27, 2015. In a web-based system, the software such as a graphics software, application, plugin, or other tool used to calculate the out-of-gamut score may be provided to a user over a network such as the Internet. In a cloud-based system, the software such as a graphics software, application, plugin, or other tool may be available to a user in a hosted design space, such as that described in U.S. Provisional Patent Application No. 62/139,261. With either a web-based system or a cloud-based system, a user may generally obtain the benefit of the out-of-gamut score calculation without the need for acquiring local software or hardware.

It may be appreciated that the methods of the present disclosure may provide for an out-of-gamut determination of an image on a device without the need to actually or physically render the image on the device. That is, the color space in which the device operates may be applied to a digital image, without sending the image to the device or rendering the image at the device. For example, where the device is a printer operating in a CMYK color space, a digital image may be converted from, for example, an RGB color space, to the CMYK color space of the printer, and back to the RGB color space for comparison and score calculation. In this way, it may be determined digitally whether the image is likely to be out of gamut when it is rendered at the printer, without actually sending the image to the printer and without printing the image.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a personal computer (e.g., desktop or laptop), tablet computer, mobile device (e.g., personal digital assistant (PDA) or smart phone), server (e.g., blade server or rack server), a network storage device, or any other suitable device or combination of devices and may vary in size, shape, performance, functionality, and price. A system may include random access memory (RAM), one or more processing resources such as a central processing unit (CPU) or hardware or software control logic, ROM, and/or other types of nonvolatile memory. Additional components of a system may include one or more disk drives or one or more mass storage devices, one or more network ports for communicating with external devices as well as various input and output (I/O) devices, such as a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, or any combination of storage devices. A system may include what is referred to as a user interface, which may generally include a display, mouse or other cursor control device, keyboard, button, touchpad, touch screen, microphone, camera, video recorder, speaker, LED, light, joystick, switch, buzzer, bell, and/or other user input/output device for communicating with one or more users or for entering information into the system. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices. A system may also include one or more buses operable to transmit communications between the various hardware components.

One or more programs or applications, such as a web browser, and/or other applications may be stored in one or more of the system data storage devices. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information.

Hardware and software components of the present disclosure, as discussed herein, may be integral portions of a single computer or server or may be connected parts of a computer network. The hardware and software components may be located within a single location or, in other embodiments, portions of the hardware and software components may be divided among a plurality of locations and connected directly or through a global computer information network, such as the Internet.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart may illustrate a method as a sequential process, many of the operations in the flowcharts illustrated herein can be performed in parallel or concurrently. In addition, the order of the method steps illustrated in a flowchart may be rearranged for some embodiments. Similarly, a method illustrated in a flow chart could have additional steps not included therein or fewer steps than those shown. A method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

We claim:

1. A method for determining whether an image is out of gamut for a device, comprising:
receiving a source image in a first color space, the first color space corresponding to a first device;
converting the image to a second color space, the second color space corresponding to a second device;
converting the image back to the first color space, to produce a converted image;
comparing the source image and the converted image; and
calculating an out-of-gamut score for the converted image.

2. The method of claim 1, wherein the source image and converted image each comprise a plurality of pixels, and wherein the score is the root mean square variance between the plurality of pixels in the source image and the plurality of pixels in the converted image.

3. The method of claim 1, wherein the source image and converted image each comprise a plurality of pixels, and wherein the score is the mean distance between the plurality of pixels in the source image and the plurality of pixels in the converted image.

4. The method of claim 1, wherein the first color space is defined as an RGB color space.

5. The method of claim 4, wherein the second color space is defined as a CMYK color space.

6. The method of claim 1, further comprising comparing the out-of-gamut score to a threshold value.

7. The method of claim 6, further comprising notifying a user if the out-of-gamut score exceeds the threshold value.

8. The method of claim 1, wherein an out-of-gamut score is calculated for an individual color channel.

9. The method of claim 1, wherein an out-of-gamut score is calculated for a particular color.

10. A method for determining whether an image is out of gamut for a device, comprising:
importing an image to a first color space, to produce a source image;
converting at least a portion of the image to a second color space;
converting the at least a portion of the image back to the first color space, to produce a converted image;
comparing the source image and the converted image; and
based on the comparison, calculating an out-of-gamut score for the converted image.
